(19) United States
(12) Patent Application Publication
(10) Pub. No.: US 2026/0007550 A1
(43) Pub. Date: Jan. 8, 2026

(54) SWIVEL METAL TONGUE FOR LAP AND SHOULDER BELT ATTACHMENT

(71) Applicant: AMF-BRUNS GmbH & Co. KG, Apen (DE)

(72) Inventor: Jose C. ESTEIREIRO, Hudson, OH (US)

(21) Appl. No.: 18/762,869

(22) Filed: Jul. 3, 2024

(51) Int. Cl. A61G 3/08; B60P 7/08

(52) U.S. Cl. CPC A61G 3/0808; B60P 7/0823

(57) ABSTRACT

Provided in this disclosure is a retractor, which could be used in a wheelchair restraint system. The present retractor includes a retractor body for receiving and retracting a strap to be tensioned. The present retractor also includes a tongue assembly securely connected to the retractor body for mechanically engaging a buckle of a belt. The tongue assembly includes a first tongue portion for securely connecting to the retractor body. A second tongue portion includes an aperture for mechanically engaging with the buckle of the belt. A swivel is provided for rotatably connecting the first tongue portion to the second tongue portion, thereby permitting rotation of the first tongue portion with respect to the second tongue portion.

### I. Background

### A. Technical Field

The present disclosure pertains to the field of safely securing a wheelchair to a passenger transport vehicle such as a van in a sufficient manner to ensure the safety of the wheelchair occupant.

### B. Description of Related Art

Safety requirements have been established for transporting wheelchair passengers, such as in school buses and other public vehicles. Industry standards for safety restraints include seat belts for wheelchairs.

As depicted in FIGS. 1A, 1B, and 1C, various vehicular transport safety standards require a wheelchair 10 to be secured to the vehicle floor at four anchor points using retractors 12a, 12b, 12c, 12d which each engage a respective retractable tensioning strap 14a, 14b, 14c, 14d that are each removably connected to the wheelchair 10. The retractors 12a, 12b, 12c, 12d each apply a retraction force upon their associated tensioning straps 14a, 14b, 14c, 14d and thereby securely engage and retain the wheelchair 10 against movement within the vehicle. The retractors 12a, 12b, 12c, 12d can be secured to the vehicle floor using any known apparatus, such as the configuration disclosed in co-pending U.S. Ser. No. 18/471,525 entitled L-TRACK FITTING INCLUDING SAFETY LOCK VISUAL PIN, the entirety of which is hereby incorporated by reference.

As further depicted in FIGS. 1A, 1B, and 1C, the retractors include rear retractors 12a, 12b for connecting to rear straps 14a, 14b that connect to and support the rear of the wheelchair 10. The retractors also include front retractors 12c, 12d for connecting to front straps 14c, 14d that connect to and support the front of the wheelchair 10. The wheelchair 10 also includes a lap belt 16 that secures the passenger to the wheelchair 10 and also a shoulder belt 18 which is mounted on the vehicle wall and securely fits over the shoulder of the passenger to connect to the wheelchair 10.

With specific reference to FIGS. 1B and 1C, the lap belt 16 and shoulder belt 18 can include various configurations of extensions in order to comply with various safety standards. In one exemplary aspect depicted in these figures, extensions 16a, 18a associated respectively with the lap and shoulder belts 16, 18 can extend to the rear of the wheelchair 10 and can include respective buckles 16aa, 18aa configured to each connect with an associated metal tongue 20a, 20b securely mounted onto the rear retractors 12a, 12b in order to stabilize the belts 16, 18 to the retractors 12a, 12b and thereby provide safety. Other exemplary configurations of belts and extensions can be implemented to comply with various other safety standards.

As indicated in FIGS. 1A, 1B, and 1C, the metal tongues 20a, 20b are typically formed to stick up and away from the retractors 12a, 12b in order to engage the buckles 16aa, 18aa. The metal tongues 20a, 20b are known to catch on things when not in use for securing the wheelchair 10 to the vehicle. For example, the tongues 20a, 20b have been found to catch on clothing such as pant legs of vehicle personnel, and to otherwise create an obstruction and a safety hazard when not in use.

### II. Summary

Provided in this disclosure is a retractor, which could be used in a wheelchair restraint system. The present retractor includes a retractor body for receiving and retracting a strap to be tensioned. The present retractor also includes a tongue assembly securely connected to the retractor body for mechanically engaging a buckle of a belt. The tongue assembly includes a first tongue portion for securely connecting to the retractor body. A second tongue portion includes an aperture for mechanically engaging with the buckle of the belt. A swivel is provided for rotatably connecting the first tongue portion to the second tongue portion, thereby permitting rotation of the first tongue portion with respect to the second tongue portion.

In one aspect of the present retractor, the swivel permits 360 degrees of rotation of the second tongue portion with respect to the first tongue portion. In another aspect, of the present retractor, a stop is configured to restrict an angle of rotation of the second tongue portion with respect to the first tongue portion.

In one exemplary aspect of the present retractor, the stop can be configured to restrict the angle of rotation to 90 degrees. The stop can be formed onto the first tongue portion for restricting rotation of the second tongue portion. The stop can include a first stop portion formed on a first edge of the first tongue portion for restricting the second tongue portion to an angle of zero degrees with respect to a longitudinal axis of the tongue assembly. The stop can further include a second stop portion formed on a second edge of the first tongue portion, opposite the first edge, for restricting the second tongue portion to an angle of 90 degrees with respect to the longitudinal axis of the tongue assembly.

In another exemplary aspect of the present retractor, the stop can include first and second mating structures formed either the first or second tongue portions at different angles of rotation. The stop can also include a third mating structure formed on the respective other of the first or second tongue portions for selectively rotationally engaging one of the first or second mating structures. Specifically, the first and second mating structures can be first and second recesses formed onto the first tongue portion. The third mating structure can then be a dome formed onto the second tongue portion configured for being selectively rotationally received within one of the first and second recesses.

In yet another exemplary aspect of the present retractor, the stop can be a pin formed onto one of the first or second tongue portions. The pin engages one or more abutting surfaces on the respective other of the first or second tongue portions to restrict rotational movement. Specifically, the pin can be formed onto the first tongue portion, and then the abutting surfaces are formed along a distal edge of the second tongue portion.

In still another exemplary aspect of the present retractor, the stop can be a sleeve member fitted upon one of the first or second tongue portions. The sleeve member has a rotational surface configured to permit rotation of the respective other of the first or second tongue portions. Specifically, the sleeve member is fitted upon the first tongue portion and further comprises first and second edges for contacting respective first and second opposing edges of the second tongue portion, for restricting the angle of rotation of the second tongue portion. The second tongue portion can have a semicircular distal edge concentric with an axis of rotation of the second tongue portion. The rotational surface of the sleeve member includes a circular surface that conforms to the semicircular distal edge of the second tongue portion. The first and second edges of the sleeve portion adjoin the circular surface.

Other aspects of the tongue assembly can be contemplated for mechanically engaging a buckle of a belt which do not involve a retractor. Such a tongue assembly can include a first tongue portion for securely connecting to a mounting member and a second tongue portion including an aperture for mechanically engaging with the buckle of the belt. A swivel is provided for rotatably connecting the first tongue portion to the second tongue portion, thereby permitting rotation of the first tongue portion with respect to the second tongue portion.

In one aspect of the present tongue assembly, the swivel permits 360 degrees of rotation of the first tongue portion with respect to the second tongue portion. In another aspect, a stop configured to restrict an angle of rotation of the first tongue portion with respect to the second tongue portion.

In one exemplary aspect of the tongue assembly, stop can be configured to restrict the angle of rotation to 90 degrees. The stop can be formed onto the first tongue portion for restricting rotation of the second tongue portion. The stop can include a first stop portion formed on a first edge of the first tongue portion for restricting the second tongue portion to an angle of zero degrees with respect to a longitudinal axis of the tongue assembly. The stop can further include a second stop portion formed on a second edge of the first tongue portion, opposite the first edge, for restricting the second tongue portion to an angle of 90 degrees with respect to the longitudinal axis of the tongue assembly.

According to one aspect, the present tongue assembly can be swiveled to not stick up and away from the retractors when not in use for engaging a buckle.

According to another aspect, the present tongue assembly can be swiveled when not in use in order to not catch on things, such as clothing of vehicle personnel.

According to yet another aspect, the present tongue assembly can be swiveled so as to not create an obstruction and a safety hazard when not in use.

Other benefits and advantages of the present teaching will become apparent to those skilled in the art to which it pertains upon reading and understanding of the following detailed specification.

### III. BRIEF DESCRIPTION OF THE DRAWINGS

The disclosed tongue assembly and retractor may take physical form in certain parts and arrangement of parts, aspects of which will be described in detail in this specification and illustrated in the accompanying drawings which form a part hereof and wherein:

FIGS. 1A, 1B, and 1C are various perspective views showing a wheelchair safety restraint operating in cooperation with a metal tongue in accordance with the prior art.

FIGS. 2A, 2B, 2C, and 2D are perspective views depicting a retractor utilizing a tongue assembly in four different operative configurations in accordance with a first exemplary aspect.

FIGS. 3A, 3B, 3C, and 3D are respective top, side exploded, side assembled and exploded perspective views of the tongue assembly in accordance with a second exemplary aspect.

FIGS. 4A, 4B, 4C, 4D, and 4E are respective oblique, side, two frontal oblique, and perspective views of the first tongue portion of the tongue assembly in accordance with the second exemplary aspect.

FIGS. 5A, 5B, 5C, and 5D are respective top, perspective, and two side views of the second tongue portion of the tongue assembly in accordance with the second exemplary aspect.

FIGS. 6A, 6B, and 6C are respectively a first perspective view, a second perspective view, and an exploded view showing operative states of the tongue assembly in accordance with the second exemplary aspect.

FIGS. 7A, 7B, 7C, and 7D are three perspective views and an underside view showing operative states of the tongue assembly in accordance with a third exemplary aspect.

FIGS. 8A, 8B, 8C, and 8D are perspective and top views showing operative states of the tongue assembly in accordance with a fourth exemplary aspect.

FIGS. 9A, 9B, and 9C are perspective and underside views showing operative states of the tongue assembly in accordance with a fifth exemplary aspect.

FIGS. 10A, 10B, 10C, 10D, and 10E are perspective and underside views showing operative states of the tongue assembly in accordance with a sixth exemplary aspect.

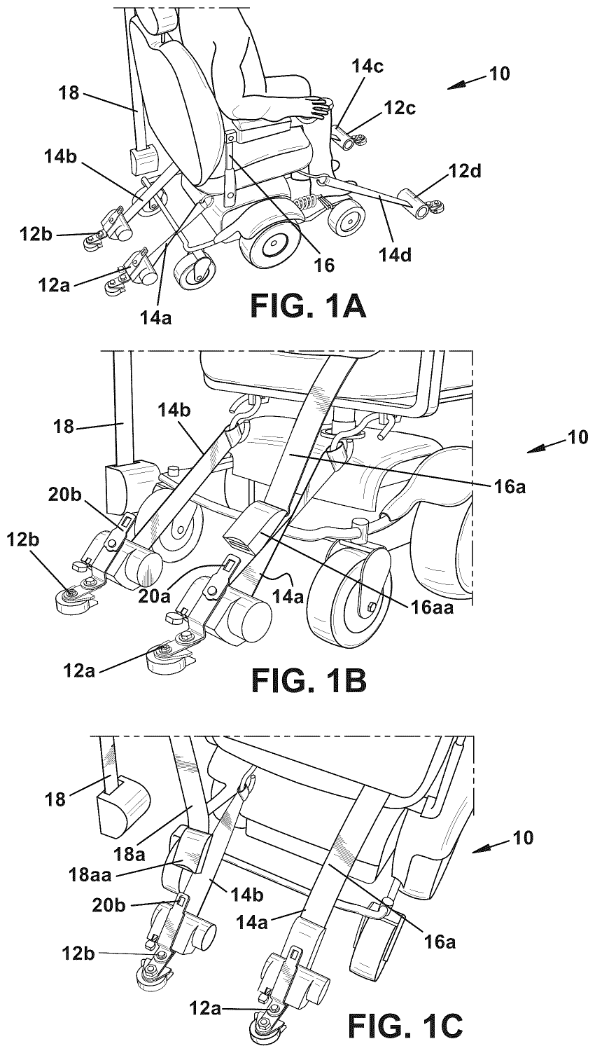

### IV. DETAILED DESCRIPTION

Referring now to the drawings wherein the showings are for purposes of illustrating aspects of the article only and not for purposes of limiting the same, and wherein like reference numerals are understood to refer to like components:

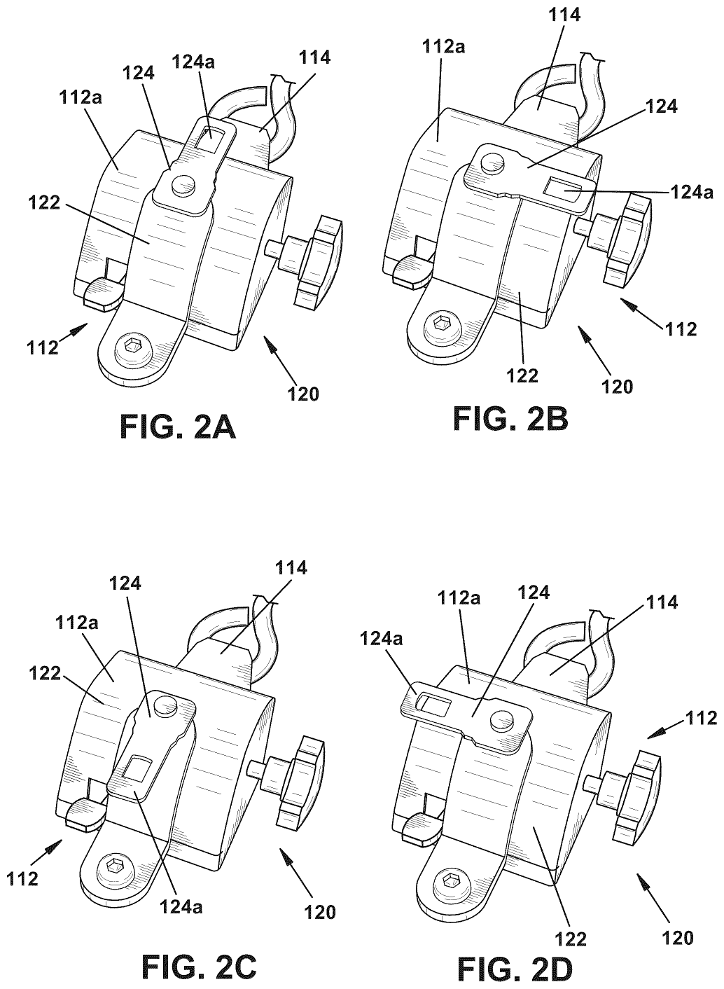

With specific reference to FIGS. 2A, 2B, 2C, and 2D, a retractor 112 is disclosed including a retractor body 112a for receiving and retracting a strap 114 to be tensioned. The retractor 112 can be of any conventional design and can include standard internal components such as a coil spring for applying tension to the strap 114 upon extension from the retractor 112.

With continued reference to FIGS. 2A, 2B, 2C, and 2D, the retractor 112 includes a tongue assembly 120 securely connected to the retractor body 112a for mechanically engaging a buckle of a belt, which can be a 3 pt belt 16aa or a shoulder belt buckle 18aa as described hereinabove, or any other suitable buckle for connecting to a metal tongue. Generally, the tongue assembly 120 includes a first tongue portion 122 for securely connecting to the retractor body 112a. The tongue assembly 120 also includes a second tongue portion 124 including an aperture 124a for mechanically engaging with the buckle of the belt (e.g., a 3 pt belt 16aa or a shoulder belt buckle 18aa). The tongue assembly 120 further includes a swivel 126 for rotatably connecting the first tongue portion 122 to the second tongue portion 124, thereby permitting rotation of the first tongue portion 122 with respect to the second tongue portion 124.

With ongoing reference to an aspect depicted in FIGS. 2A, 2B, 2C, and 2D, the tongue assembly 120 of the retractor 112 is configured in such a way that the swivel 126 permits 360 degrees of rotation of the second tongue portion 124 with respect to the first tongue portion 122. As shown in FIG. 2A, the second tongue portion 124 can be swiveled into an operative orientation, generally parallel to the first tongue portion 122, where it can receive a buckle for engagement. As shown in FIG. 2B, the second tongue portion 124 can be swiveled 90 degrees clockwise with respect to the first tongue portion 122, where it does not stick up from the retractor 112 when not engaging a buckle, and thereby does not catch on clothing or otherwise create an obstruction and a safety hazard when not in use. As shown in FIG. 2C, the second tongue portion 124 can be swiveled 180 degrees with respect to the first tongue portion 122, where it is similarly removed from being an obstruction or safety hazard. Further, as shown in FIG. 2D, the second tongue portion 124 can be swiveled 270 degrees clockwise (i.e., 90 degrees counterclockwise) with respect to the first tongue portion 122, where it is again does not pose an obstruction or safety hazard.

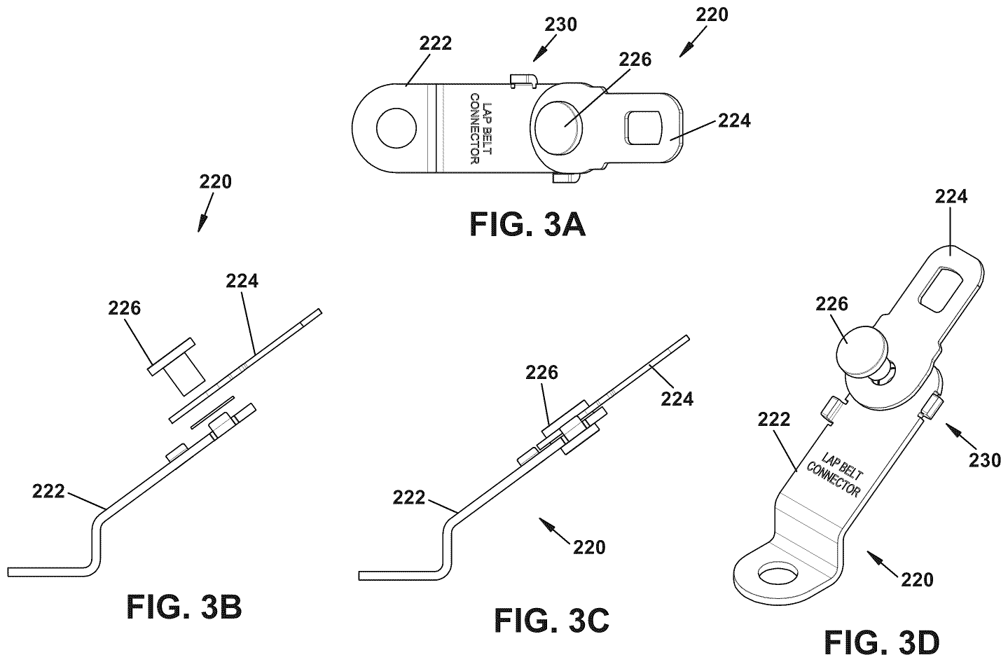

In accordance with the second, third, fourth, fifth, and sixth aspects shown in the remaining figures, a retractor can include a tongue assembly having a stop configured to restrict the angle of rotation of the second tongue portion with respect to the first tongue portion. In the second exemplary aspect depicted in FIGS. 3A, 3B, 3C, and 3D, a tongue assembly 220 is provided having a first tongue portion 222 and a second tongue portion 224 with a swivel 226, all of which are configured in accordance with the descriptions hereinabove. A stop 230 is provided that is configured to restrict the angle of rotation to 90 degrees. It should be appreciated that all the herein-disclosed aspects include first and second tongue portions and a swivel, even if these components are not explicitly depicted in each of the subsequent drawings, and each aspect should be construed as operably comporting with FIGS. 3A, 3B, 3C, and 3D.

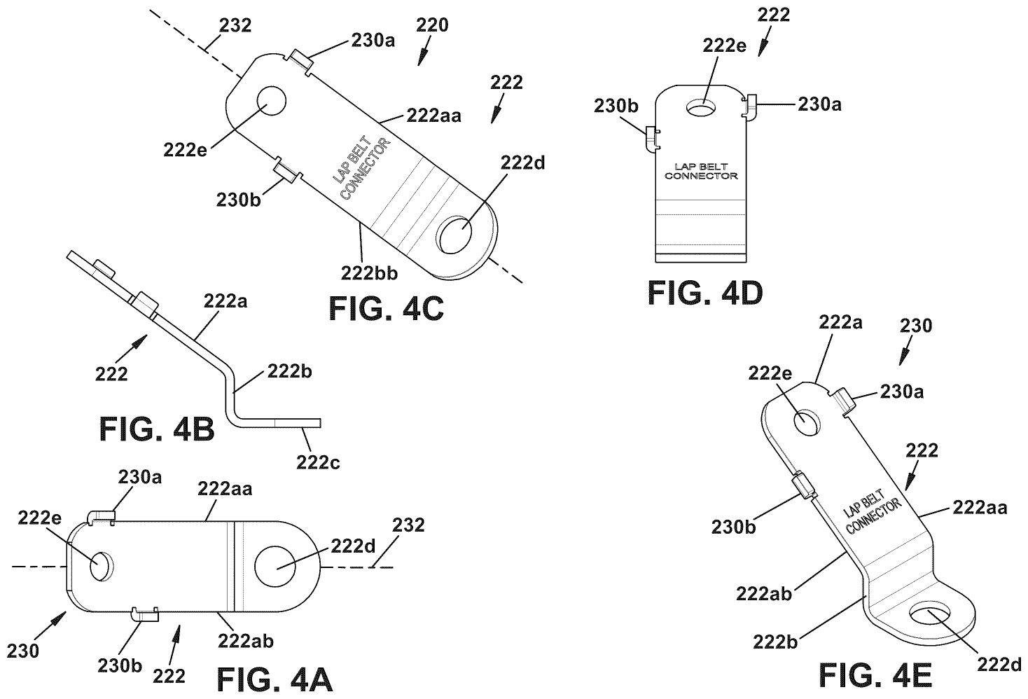

With specific reference to the second exemplary aspect, FIGS. 4A, 4B, 4C, 4D, and 4E depict the first tongue portion 222. As best seen in the views of FIGS. 4A, 4C and 4D, the first tongue portion 222 preferably has a generally rectangular shape with rounded ends. As evident from FIGS. 4B and 4E, the first tongue portion 222 is preferably formed so as to conform with the shape of the retractor body upon which it is attached. To that end, there is an angled portion 222a, a vertical portion 222b, and a horizontal portion 222c. The angled portion 222a contacts the retractor body while the vertical and horizontal portions 222b, 222c attach the tongue assembly 220 to the vehicle floor, and the horizontal portion 222c includes a hole 222d for receiving a bolt for securing the tongue assembly 220 and the retractor to the vehicle floor. The angled portion 222a includes a hole 222e for receiving the swivel 226, thereby enabling connecting of the first and second tongue portions 222, 224.

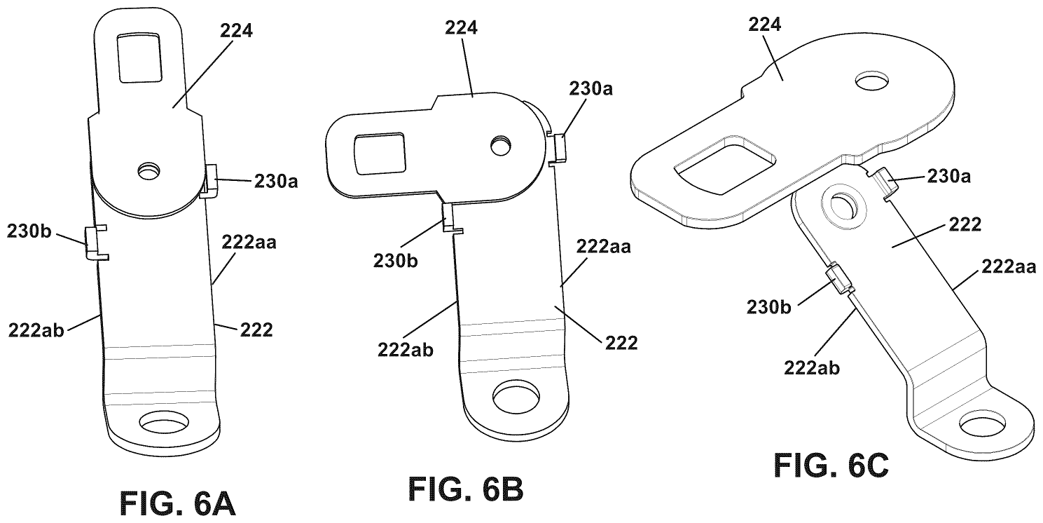

With ongoing reference to the second exemplary aspect, with respect to the first tongue portion 222 of FIGS. 4A, 4B, 4C, 4D, and 4E, the stop 230 is formed onto the first tongue portion 222 for restricting rotation of the second tongue portion 224. In particular, the stop 230 includes a first stop portion 230a formed on a first edge 222aa of the angled portion 222a of the first tongue portion 222. The first stop portion 230a is preferably a piece that extends upwardly from the first edge 222aa to restrict the rotational movement of the second tongue portion 224 to an angle of zero degrees with respect to a longitudinal axis 232 of the tongue assembly (i.e., so that the first tongue portion 222 and the second tongue portion 224 are parallel to the longitudinal axis of the tongue assembly 220, as shown hereinabove in the configuration of FIGS. 2A and 6A.

With further ongoing reference to the second exemplary aspect, FIGS. 4A, 4B, 4C, 4D, and 4E, the stop 230 also includes a second stop portion 230b formed on a second edge 222ab of the angled portion 222a of the first tongue portion 222. The second stop portion 230b is also preferably a piece that extends upwardly from the second edge 222ab to restrict the rotational movement of the second tongue portion 224 to an angle of 90 degrees with respect to the longitudinal axis 232 of the tongue assembly 220 (i.e., so that the first tongue portion 222 and the second tongue portion 224 are perpendicular, as shown hereinabove in the configuration of FIGS. 2D and 6B.)

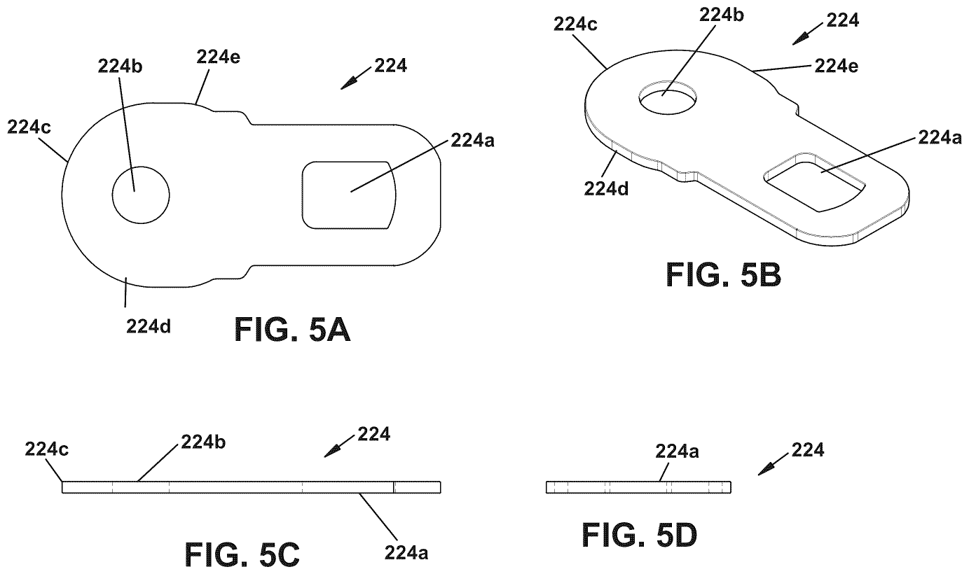

With still further ongoing reference to the second exemplary aspect, FIGS. 5A, 5B, 5C, and 5D provide details of the second tongue portion 224. The second tongue portion 224 includes an aperture 224a for mechanically engaging with the buckle of the belt (e.g., a 13 pt belt 16aa or a shoulder belt buckle 18aa as described hereinabove). The second tongue portion 224 includes a hole 224b for receiving and accommodating the swivel 226 thereby permitting rotation of the second tongue portion 224 with respect to the first tongue portion 222. The second tongue portion 224 further includes a semicircular rotational edge 224c at a distal end of the second tongue portion 224, for permitting free and uninhibited rotational movement against the first and second stop portions 230a, 230b. The rotational edge 224c adjoins first and second flat edges 224d, 224e which contact the first and second stop portions 230a, 230b to restrict rotational movement. Specifically, the first flat edge 224d contacts the first stop portion 230a to restrict rotational movement of the second tongue portion 224 at zero degrees, parallel with respect to the longitudinal axis 232 of the tongue assembly 220. Correspondingly, the second flat edge 224e contacts the second stop portion 230b to restrict rotational movement of the second tongue portion 224 at 90 degrees with respect to the longitudinal axis 232 of the tongue assembly 220.

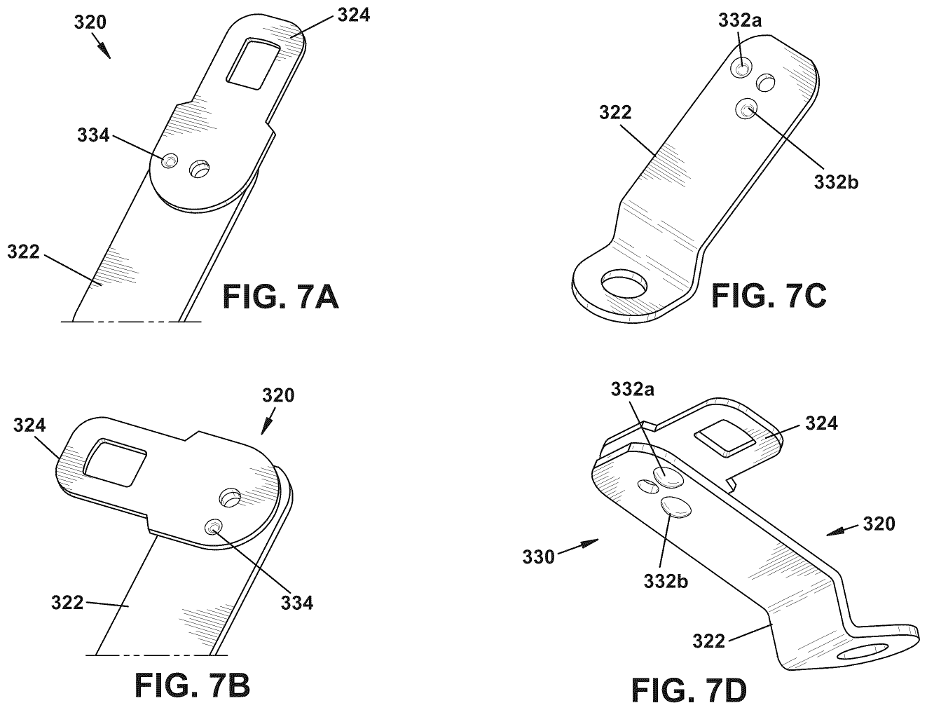

Referring now to the third exemplary aspect, FIGS. 7A, 7B, 7C, and 7D show a tongue assembly 320 generally in accordance with the aspects disclosed hereinabove and including a first tongue portion 322 and a second tongue portion 324. In the third aspect, the stop 330 is generally characterized by first and second mating structures formed onto either the first or second tongue portions 322, 324 at different angles of rotation. The stop 330 also includes a third mating structure formed on the other of the first or second tongue portions 322, 324 for selectively rotationally engaging the first or second mating structures.

As specifically depicted in FIGS. 7A, 7B, 7C, and 7D, the first and second mating structures are defined by first and second concave recesses 332a, 332b formed onto the first tongue portion 322. Correspondingly, the third mating structure is defined by a convex dome 334 formed onto the second tongue portion 324. As shown especially in FIGS. 7C and 7D, the recesses 332a, 332b are oriented at positions corresponding to a 90 degree rotational angle. The dome 334 is configured for being selectively rotationally received within one of the first and second recesses 332a, 332b. For example, as specifically shown in FIG. 7A, when the first and second tongues 322, 324 are parallel, the dome 334 is received within the first recess 332a. But when the second tongue 324 is rotated 90 degrees to be perpendicular to the first tongue 322, as shown in FIGS. 7B and 7D, the dome 334 is received within the second recess 332b.

It is of course to be appreciated that the shapes and placement of the mating structures can be transposed without departing from the innovative concept. For example, the first and second mating structures can alternatively be convex domes instead of concave recesses, in which case the third mating structure can be a concave recess instead of a convex dome. And correspondingly, the first and second mating structures can be placed on the second tongue portion 324 instead of the first tongue portion 322, in which case the third mating structure can be placed on the first tongue portion 322 instead of the second tongue portion 322.

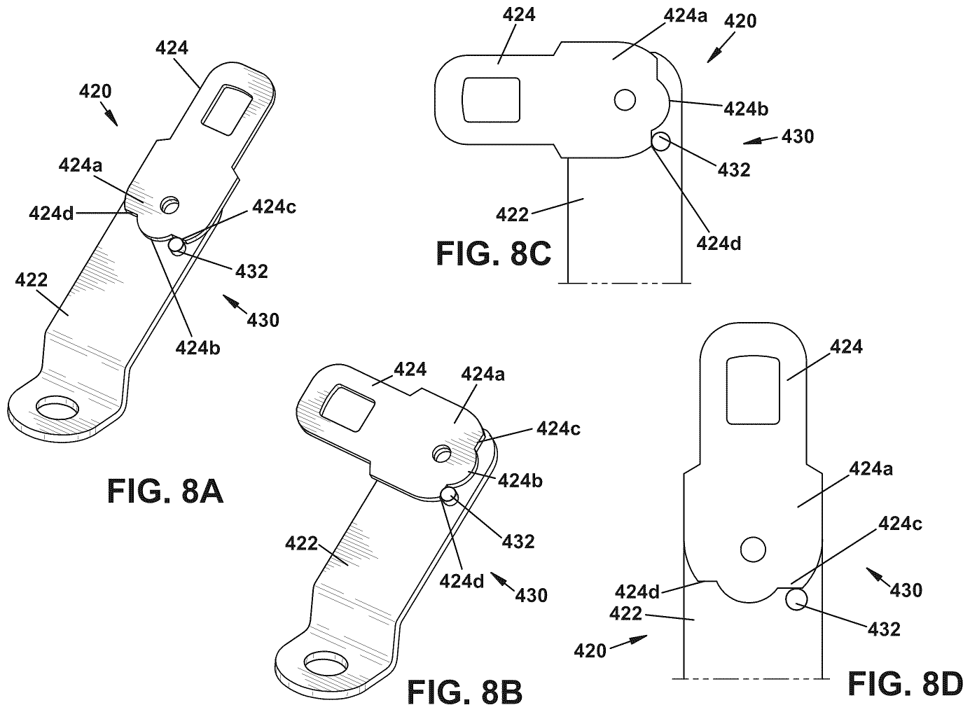

Turning now to the fourth exemplary aspect, FIGS. 8A, 8B, 8C, and 8D depict a tongue assembly 420 generally in accordance with the aspects disclosed hereinabove and including a first tongue portion 422 and a second tongue portion 424. In the fourth aspect, the stop 430 is generally characterized by a pin 432 formed onto either of the first or second tongue portions 422, 424. The pin 432 engages one or more abutting surfaces formed on the other of the first or second tongue portions 422, 424 to restrict rotational movement. Specifically, the pin 432 is preferably formed onto the first tongue portion 422. The abutting surface(s) is/are formed along a distal edge 424a of the second tongue portion 424.

As shown in FIGS. 8A, 8B, 8C, and 8D, the distal edge 424a of the second tongue portion 424 further includes a semicircular rotational edge 424b, for permitting free and uninhibited rotational movement against the pin 434. The rotational edge 424b adjoins the abutting surfaces, which are defined as first and second flat edges 424c, 424d which alternately contact the pin 434 in each orientational position. Specifically, the first flat edge 424c contacts the pin 434 to restrict rotational movement of the second tongue portion 424 at zero degrees, parallel with the first tongue portion 422, as shown in FIGS. 8A and 8D. Correspondingly, the second flat edge 424d contacts the pin 434 to restrict rotational movement of the second tongue portion 424 at 90 degrees with respect to the first tongue portion 422, as shown in FIGS. 8B and 8C.

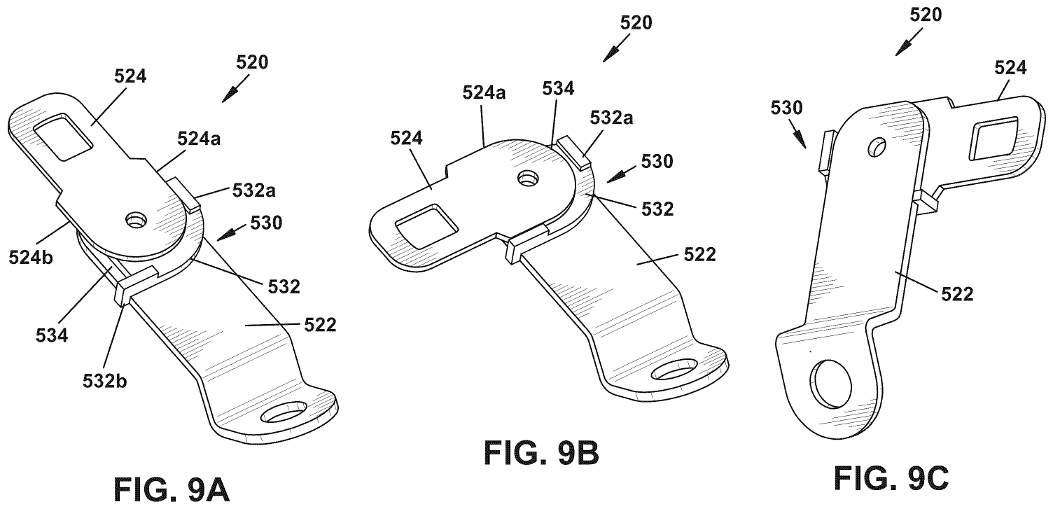

With regards to the fifth exemplary aspect, FIGS. 9A, 9B, and 9C depict a tongue assembly 520 generally in accordance with the aspects disclosed hereinabove and including a first tongue portion 522 and a second tongue portion 524. In the fifth aspect, the stop 530 is generally characterized by a sleeve member 532 fitted upon either of the first or second tongue members 522, 524. The sleeve member 532 has a rotational surface 534 configured to permit rotation of the other of the first or second tongue portions 522, 524. The sleeve member 532 is preferably a plastic component fitted upon the first tongue portion 522. The sleeve member 532 also includes a first edge 532a and a second edge 532b formed for respectively contacting a first opposing edge 524a and a second opposing edge 524b of the second tongue portion 524, for restricting the angle of rotation of the second tongue portion 524.

With further reference to FIGS. 9A, 9B, and 9C, the first edge 532a extends upwardly from the sleeve member 532 to contact the first opposing edge 524a of the second tongue portion 524 and thereby restrict the rotational movement of the second tongue portion 524 to an angle of zero degrees with respect to a longitudinal axis of the tongue assembly (i.e., so that the first tongue portion 522 and the second tongue portion 524 are parallel to the longitudinal axis of the tongue assembly 520, as shown in FIGS. 9A, as similarly shown in other aspects hereinabove). Conversely, the second edge 532b extends upwardly from the sleeve member 532 to contact the second opposing edge 524b of the second tongue portion 524 and thereby restrict the rotational movement of the second tongue portion 524 to an angle of 90 degrees with respect to a longitudinal axis of the tongue assembly (i.e., so that the first tongue portion 522 and the second tongue portion 524 are perpendicular to the longitudinal axis of the tongue assembly 520, as shown in FIG. 9B, as similarly shown in other aspects hereinabove).

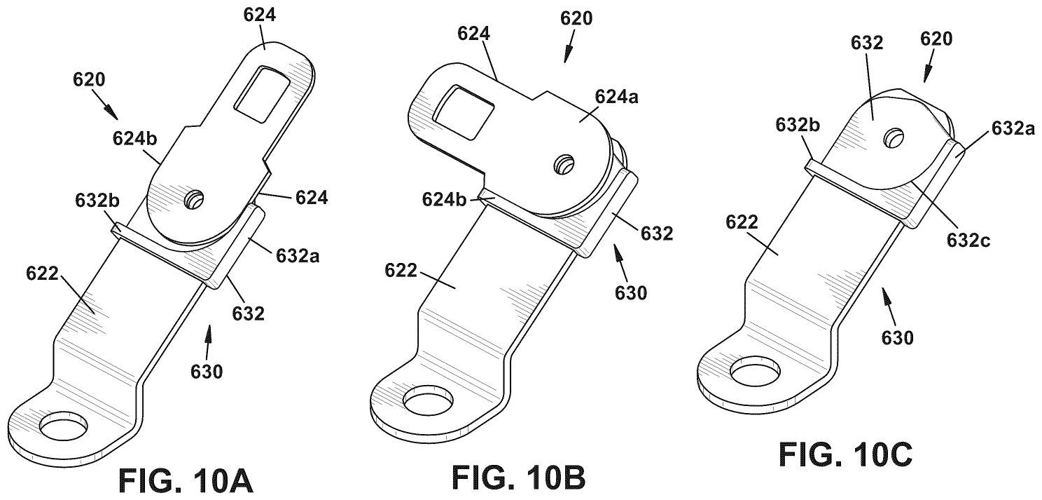

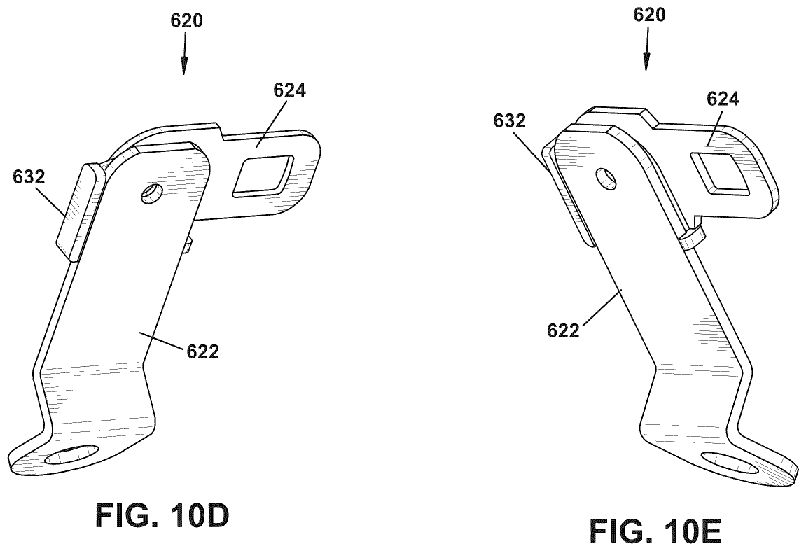

With regards to the sixth exemplary aspect, FIGS. 10A, 10B, 10C, 10D and 10E depict a tongue assembly 620 generally in accordance with the aspects disclosed hereinabove and including a first tongue portion 622 and a second tongue portion 624. In the sixth aspect, the stop 630 is generally characterized by a sleeve member 632 similar to that of the fifth aspect hereinabove, also fitted upon either of the first or second tongue members 622, 624. The sleeve member 632 has a rotational surface 634 configured to permit rotation of the other of the first or second tongue portions 622, 624. The sleeve member 632 is preferably a plastic component fitted upon the first tongue portion 622. The sleeve member 632 also includes a first edge 632a and a second edge 632b adjoin with a circular surface 632c in perpendicular directions for respectively contacting a first opposing edge 624a and a second opposing edge 624b of the second tongue portion 624, for restricting the angle of rotation of the second tongue portion 624.

With further reference to FIGS. 10A, 10B, 10C, 10D and 10E, the second tongue portion 624 has a semicircular distal edge 624c concentric with an axis of rotation of the second tongue portion 624 and adjoining the opposing edges 624a, 624b. The rotational surface 634 of the sleeve portion includes the circular surface 632c that conforms to the semicircular distal edge 624c of the second tongue portion 624. The first and second edges 632a, 632b of the sleeve portion 632 adjoin the circular surface 632c.

Many aspects of the sixth exemplary aspect of FIGS. 10A, 10B, 10C, 10D and 10E are similar in design and function to the fifth exemplary aspect of FIGS. 9A, 9B, and 9C and it should be appreciated that the aforementioned descriptions can be used interchangeably to describe aspects similar to both aspects.

It should be appreciated that the present tongue assembly and the aspects described hereinabove are not limited to only a retractor for a wheelchair but can be adapted for any use with any sort of buckle for any belt or other suitable connector. For example, the present tongue assembly could be adapted for any seat belt, for passengers in a vehicle, or to secure an infant in a car carrier, or any other sort of engagement structure which might be configured for a tongue assembly.

Clause 1—A retractor including a retractor body for receiving and retracting a strap to be tensioned, a tongue assembly securely connected to the retractor body for mechanically engaging a buckle of a belt, wherein the tongue assembly includes a first tongue portion for securely connecting to the retractor body, a second tongue portion including an aperture for mechanically engaging with the buckle of the belt, and a swivel for rotatably connecting the first tongue portion to the second tongue portion, thereby permitting rotation of the first tongue portion with respect to the second tongue portion.

Clause 2—The retractor of clause 1, wherein the swivel permits 360 degrees of rotation of the second tongue portion with respect to the first tongue portion.

Clause 3—The retractor of clauses 1 or 2, wherein the tongue assembly further comprises a stop configured to restrict an angle of rotation of the second tongue portion with respect to the first tongue portion.

Clause 4—The retractor of clauses 1-3, wherein the stop is configured to restrict the angle of rotation to 90 degrees.

Clause 5—The retractor of clauses 1-4, wherein the stop is formed onto the first tongue portion for restricting rotation of the second tongue portion.

Clause 6—The retractor of clauses 1-5, wherein the stop comprises a first stop portion formed on a first edge of the first tongue portion for restricting the second tongue portion to an angle of zero degrees with respect to a longitudinal axis of the tongue assembly.

Clause 7—The retractor of clauses 1-6, wherein the stop further comprises a second stop portion formed on a second edge of the first tongue portion, opposite the first edge, for restricting the second tongue portion to an angle of 90 degrees with respect to the longitudinal axis of the tongue assembly.

Clause 8—The retractor of clauses 1-7, wherein the stop comprises first and second mating structures formed onto one of the first or second tongue portions at different angles of rotation, and wherein the stop further comprises a third mating structure formed on the respective other of the first or second tongue portions for selectively rotationally engaging one of the first or second mating structures.

Clause 9—The retractor of clauses 1-8, wherein the first and second mating structures comprise first and second recesses formed onto the first tongue portion and wherein the third mating structure comprises a dome formed onto the second tongue portion configured for being selectively rotationally received within one of the first and second recesses.

Clause 10—The retractor of clauses 1-9, the stop comprises a pin formed onto one of the first or second tongue portions, wherein the pin engages at least one abutting surface on the respective other of the first or second tongue portions to restrict rotational movement.

Clause 11—The retractor of clauses 1-10, wherein the pin is formed onto the first tongue portion, and wherein the at least one abutting surface is formed along a distal edge of the second tongue portion.

Clause 12—The retractor of clauses 1-11, wherein the stop comprises a sleeve member fitted upon one of the first or second tongue members, the sleeve member having a rotational surface configured to permit rotation of the respective other of the first or second tongue portions.

Clause 13—The retractor of clauses 1-12, wherein the sleeve member is fitted upon the first tongue portion and further comprises first and second edges for contacting respective first and second opposing edges of the second tongue portion, for restricting the angle of rotation of the second tongue portion.

Clause 14—The retractor of clauses 1-13, wherein the second tongue portion has a semicircular distal edge concentric with an axis of rotation of the second tongue portion, and wherein the rotational surface of the sleeve member includes a circular surface that conforms to the semicircular distal edge of the second tongue portion, wherein the first and second edges of the sleeve portion adjoin the circular surface.

Clause 15—A tongue assembly for mechanically engaging a buckle of a belt, wherein the tongue assembly includes a first tongue portion for securely connecting to a mounting member, a second tongue portion including an aperture for mechanically engaging with the buckle of the belt, and a swivel for rotatably connecting the first tongue portion to the second tongue portion, thereby permitting rotation of the first tongue portion with respect to the second tongue portion.

Clause 16—The tongue assembly of clause 15, wherein the swivel permits 360 degrees of rotation of the first tongue portion with respect to the second tongue portion.

Clause 17—The tongue assembly of clauses 15 or 16, further comprising a stop configured to restrict an angle of rotation of the first tongue portion with respect to the second tongue portion.

Clause 18—The tongue assembly of clauses 15-17, wherein the stop is configured to restrict the angle of rotation to 90 degrees.

Clause 19—The tongue assembly of clauses 15-18, wherein the stop is formed onto the first tongue portion for restricting rotation of the second tongue portion.

Clause 20—The tongue assembly of clauses 15-19, wherein the stop comprises a first stop portion formed on a first edge of the first tongue portion for restricting the second tongue portion to an angle of zero degrees with respect to a longitudinal axis of the tongue assembly, wherein the stop further comprises a second stop portion formed on a second edge of the first tongue portion, opposite the first edge, for restricting the second tongue portion to an angle of 90 degrees with respect to the longitudinal axis of the tongue assembly.

Numerous aspects have been described herein. It will be apparent to those skilled in the art that the above methods and apparatuses may incorporate changes and modifications without departing from the general scope of the present teaching. It is intended to include all such modifications and alterations in so far as they come within the scope of the appended claims or the equivalents thereof.

Having thus described the present teaching, it is now claimed:

What is claimed:

1. A retractor comprising:
a retractor body for receiving and retracting a strap to be tensioned;
a tongue assembly securely connected to the retractor body for mechanically engaging a buckle of a belt;
wherein the tongue assembly comprises
a first tongue portion for securely connecting to the retractor body;
a second tongue portion including an aperture for mechanically engaging with the buckle of the belt; and
a swivel for rotatably connecting the first tongue portion to the second tongue portion, thereby permitting rotation of the first tongue portion with respect to the second tongue portion.

2. The retractor of claim 1, wherein the swivel permits 360 degrees of rotation of the second tongue portion with respect to the first tongue portion.

3. The retractor of claim 1, wherein the tongue assembly further comprises a stop configured to restrict an angle of rotation of the second tongue portion with respect to the first tongue portion.

4. The retractor of claim 3, wherein the stop is configured to restrict the angle of rotation to 90 degrees.

5. The retractor of claim 3, wherein the stop is formed onto the first tongue portion for restricting rotation of the second tongue portion.

6. The retractor of claim 5, wherein the stop comprises a first stop portion formed on a first edge of the first tongue portion for restricting the second tongue portion to an angle of zero degrees with respect to a longitudinal axis of the tongue assembly.

7. The retractor of claim 5, wherein the stop further comprises a second stop portion formed on a second edge of the first tongue portion, opposite the first edge, for restricting the second tongue portion to an angle of 90 degrees with respect to the longitudinal axis of the tongue assembly.

8. The retractor of claim 3, wherein the stop comprises first and second mating structures formed onto one of the first or second tongue portions at different angles of rotation, and wherein the stop further comprises a third mating structure formed on the respective other of the first or second tongue portions for selectively rotationally engaging one of the first or second mating structures.

9. The retractor of claim 8, wherein the first and second mating structures comprise first and second recesses formed onto the first tongue portion and wherein the third mating structure comprises a dome formed onto the second tongue portion configured for being selectively rotationally received within one of the first and second recesses.

10. The retractor of claim 3, the stop comprises a pin formed onto one of the first or second tongue portions, wherein the pin engages at least one abutting surface on the respective other of the first or second tongue portions to restrict rotational movement.

11. The retractor of claim 10, wherein the pin is formed onto the first tongue portion, and wherein the at least one abutting surface is formed along a distal edge of the second tongue portion.

12. The retractor of claim 3, wherein the stop comprises a sleeve member fitted upon one of the first or second tongue members, the sleeve member having a rotational surface configured to permit rotation of the respective other of the first or second tongue portions.

13. The retractor of claim 12, wherein the sleeve member is fitted upon the first tongue portion and further comprises first and second edges for contacting respective first and second opposing edges of the second tongue portion, for restricting the angle of rotation of the second tongue portion.

14. The retractor of claim 13, wherein the second tongue portion has a semicircular distal edge concentric with an axis of rotation of the second tongue portion, and wherein the rotational surface of the sleeve member includes a circular surface that conforms to the semicircular distal edge of the second tongue portion, wherein the first and second edges of the sleeve portion adjoin the circular surface.

15. A tongue assembly for mechanically engaging a buckle of a belt, wherein the tongue assembly comprises:
a first tongue portion for securely connecting to a mounting member;
a second tongue portion including an aperture for mechanically engaging with the buckle of the belt; and
a swivel for rotatably connecting the first tongue portion to the second tongue portion, thereby permitting rotation of the first tongue portion with respect to the second tongue portion.

16. The tongue assembly of claim 15, wherein the swivel permits 360 degrees of rotation of the first tongue portion with respect to the second tongue portion.

17. The tongue assembly of claim 15, further comprising a stop configured to restrict an angle of rotation of the first tongue portion with respect to the second tongue portion.

18. The tongue assembly of claim 17, wherein the stop is configured to restrict the angle of rotation to 90 degrees.

19. The tongue assembly of claim 17, wherein the stop is formed onto the first tongue portion for restricting rotation of the second tongue portion.

20. The tongue assembly of claim 19, wherein the stop comprises a first stop portion formed on a first edge of the first tongue portion for restricting the second tongue portion to an angle of zero degrees with respect to a longitudinal axis of the tongue assembly, wherein the stop further comprises a second stop portion formed on a second edge of the first tongue portion, opposite the first edge, for restricting the second tongue portion to an angle of 90 degrees with respect to the longitudinal axis of the tongue assembly.
